(19) United States
(12) Patent Application Publication
(10) Pub. No.: US 2025/0306522 A1
(43) Pub. Date: Oct. 2, 2025

(54) PROCESS CARTRIDGE AND IMAGE-FORMING APPARATUS

(71) Applicant: Zhuhai Pantum Electronics Co., Ltd., Zhuhai (CN)

(72) Inventors: Feng CHEN, Zhuhai (CN); Zhiwei LING, Zhuhai (CN)

(21) Appl. No.: 19/232,520

(22) Filed: Jun. 9, 2025

Related U.S. Application Data
(63) Continuation of application No. PCT/CN2024/083511, filed on Mar. 25, 2024.

(30) Foreign Application Priority Data
Mar. 24, 2023 (CN) 202310305121.6
Mar. 18, 2024 (CN) 202410309113.3

(51) Int. Cl. G03G 21/06; G03G 15/00; G03G 21/16; G03G 21/18

(52) U.S. Cl. CPC G03G 21/06; G03G 15/80; G03G 21/1652; G03G 21/1814; G03G 2215/00978

(57) ABSTRACT

The present disclosure provides a process cartridge and an image-forming apparatus. The process cartridge, detachably mounted on an image-forming apparatus, includes a cartridge body; a photosensitive drum, rotatably disposed on the cartridge body; and a chip, configured to be disposed on the cartridge body, where the chip includes a power supply contact configured to receive power provided by the image-forming apparatus. The power supply contact is configured to be electrically connected to a discharge component, and the discharge component is configured to eliminate residual charge on the photosensitive drum.

### CROSS-REFERENCE TO RELATED APPLICATION

This application is a continuation application of PCT Patent Application No. PCT/CN2024/083511, filed on Mar. 25, 2024, which claims the priority to Chinese patent application No. 202310305121.6, filed on Mar. 24, 2023, and No. 202410309113.3, filed on Mar. 18, 2024, the entirety of all of which is incorporated herein by reference.

### TECHNICAL FIELD

The present disclosure generally relates to the field of image-forming technology and, more particularly, relates to a process cartridge and an image-forming apparatus.

### BACKGROUND

In the existing technology, in order to obtain better images, chips may be installed on consumables (e.g., toner cartridges and the like) to record the lifetime of the consumables through the chips, such that the printer may be adjusted according to the lifetime of the consumables; or a discharge component may be added to make the potential on the surface of a photosensitive drum more stable, thereby optimizing printing quality.

However, with optimization change of the consumables, more contacts may be configured on a consumables side, which also indicates that more terminals may need to be configured at corresponding positions of an image-forming apparatus. In the existing technology, additional power supply pin may be configured on the image-forming apparatus side to power the discharge component. Since the internal space of the image-forming apparatus is limited, in order to ensure the stability of power supply to the discharge component (lamp), the position layout and structural design of the power supply pin inside the image-forming apparatus may need extremely high requirement, which may result in cost increase of the image-forming apparatus, a more complicated structural design and a larger device size.

### SUMMARY

One aspect of the present disclosure provides a process cartridge, detachably mounted on an image-forming apparatus. The process cartridge includes a cartridge body; a photosensitive drum, rotatably disposed on the cartridge body; and a chip, configured to be disposed on the cartridge body, where the chip includes a power supply contact configured to receive power provided by the image-forming apparatus. The power supply contact is configured to be electrically connected to a discharge component, and the discharge component is configured to eliminate residual charge on the photosensitive drum.

Another aspect of the present disclosure provides an image-forming apparatus. The image-forming apparatus includes an image-forming unit, configured to perform an image-forming operation; and a power supply pin, configured to supply power to a chip disposed on a cartridge body of a process cartridge when the process cartridge is installed in the image-forming apparatus, and further configured to supply power to the discharge component, where the discharge component is configured to eliminate residual charge on a photosensitive drum.

Other aspects of the present disclosure may be understood by those skilled in the art in light of the description, the claims, and the drawings of the present disclosure.

### BRIEF DESCRIPTION OF THE DRAWINGS

FIG. 1 illustrates a structural schematic of an image-forming apparatus when a front cover is removed provided by exemplary embodiments of the present disclosure.

FIG. 2 illustrates a cross-sectional view of an image-forming apparatus provided by exemplary embodiments of the present disclosure.

FIG. 3 illustrates a partial enlarged view of a position A in FIG. 2.

FIG. 4 illustrates a structural schematic of a process cartridge provided by exemplary embodiments of the present disclosure.

FIG. 5 illustrates an electrical connection structural schematic of a photosensitive drum, a chip and a discharge component provided by exemplary embodiments of the present disclosure.

FIG. 6 illustrates another electrical connection structural schematic of a

photosensitive drum, a chip and a discharge component provided by exemplary embodiments of the present disclosure.

FIG. 7 illustrates a structural schematic of an electrical connection circuit of a chip of a process cartridge, an image-forming apparatus and a discharge component provided by exemplary embodiments of the present disclosure.

FIG. 8 illustrates an electrical connection structural schematic of a chip of a process cartridge, an image-forming apparatus, an OPC (organic photoconductor) steel axle and a discharge component provided by exemplary embodiments of the present disclosure.

FIG. 9 illustrates an electrical connection structural schematic of a chip of a process cartridge, an image-forming apparatus and a discharge component provided by exemplary embodiments of the present disclosure.

FIG. 10 illustrates another electrical connection structural schematic of a chip of a process cartridge, an image-forming apparatus, an OPC steel axle and a discharge component provided by exemplary embodiments of the present disclosure.

FIG. 11 illustrates an electrical connection structural schematic of a power supply contact of a chip, a first detection control module and a discharge component provided by exemplary embodiments of the present disclosure.

FIG. 12 illustrates an electrical connection structural schematic of a power supply contact of a chip and a second detection control module provided by exemplary embodiments of the present disclosure.

FIG. 13 illustrates an electrical connection structural schematic of a signal trigger in a second detection control module, a chip and an image-forming apparatus provided by exemplary embodiments of the present disclosure.

FIG. 14 illustrates an electrical connection structural schematic of a power supply contacts of a chip, a third detection control module and a discharge component provided by exemplary embodiments of the present disclosure.

FIG. 15 illustrates an electrical connection structural schematic of an image-forming apparatus, a power supply contact of a chip, and a discharge component provided by exemplary embodiments of the present disclosure.

FIG. 16 illustrates an electrical connection structural schematic of an image-forming apparatus and a discharge component provided by exemplary embodiments of the present disclosure.

FIG. 17 illustrates an electrical connection structural schematic of an image-forming apparatus and a discharge component provided by exemplary embodiments of the present disclosure.

### DETAILED DESCRIPTION

To clearly describe the objectives, technical solutions and advantages of the present disclosure, the present disclosure is further described in detail with reference to accompanying drawings and embodiments hereinafter. It may be understood that embodiments described herein may be only configured to explain the present disclosure, but not to limit the present disclosure.

In the specification of the present disclosure, unless otherwise expressly specified and limited, the terms “first” and “second” may be only used for the purpose of description and should not be construed as indicating or implying relative importance. Unless otherwise specified or explained, the term “plurality” refers to two or more; the terms “connection”, “fixation” and the like should be understood in a broad sense. For example, “connection” may be a fixed connection, a detachable connection, an integral connection, or an electrical connection; and may be a direct connection or an indirect connection through an intermediate medium. For those skilled in the art, specific meanings of above-mentioned terms in the present disclosure should be understood according to specific cases.

In the specification of the present disclosure, it should be understood that directional terms such as “upper” and “lower” described in embodiments of the present disclosure may be described from the angles shown in accompanying drawings and should not be construed as a limitation on embodiments of the present disclosure. In addition, in the context of the present disclosure, it should also be understood that when an element may be referred to being “on” or “under” another element, the element may not only be directly connected “on” or “under” another element, but also indirectly connected “on” or “under” another element through intermediate elements.

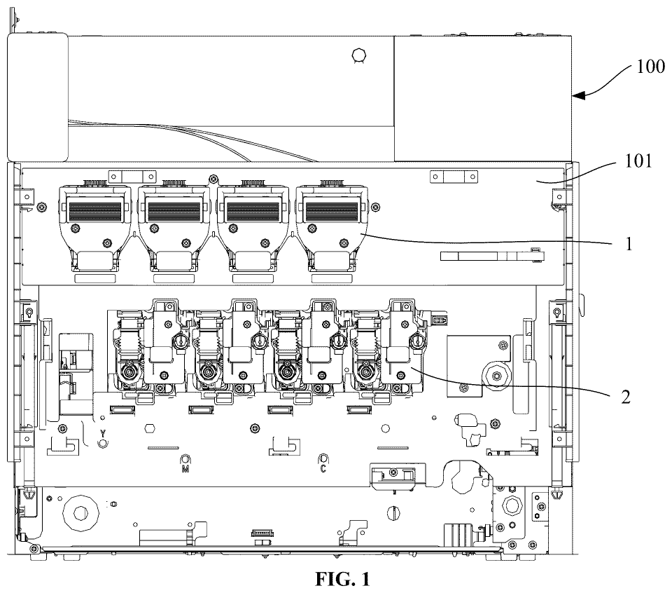

Referring to FIG. 1, FIG. 1 illustrates a structural schematic of an image-forming apparatus when a front cover is removed provided by exemplary embodiments of the present disclosure. The image-forming apparatus 100 may include a main body 101. The main body 101 may be configured with a toner cartridge 1 and a process cartridge 2. For example, the toner cartridge 1 may be configured to store toner and transport the toner to the process cartridge 2; and the process cartridge 2 may be configured to form the image to be printed on the paper during the printing process of the image-forming apparatus 100.

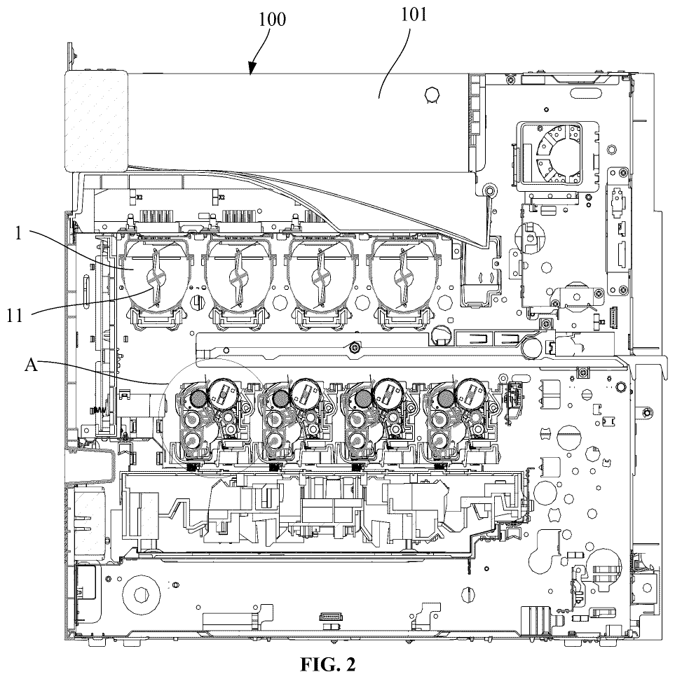

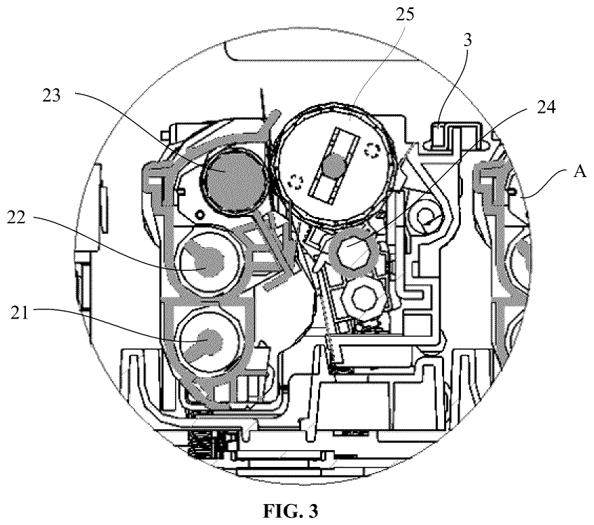

Referring to FIGS. 2-3, FIG. 2 illustrates a cross-sectional view of an image-forming apparatus provided by exemplary embodiments of the present disclosure; and FIG. 3 illustrates a partial enlarged view of a position A in FIG. 2. The toner cartridge 1 may include a stirring frame 11, and the process cartridge 2 may include a cartridge body, a stirring screw 21, a toner supply screw 22, a magnetic roller 23, a charging roller 24 and a photosensitive drum 25 (i.e., OPC organic photoconductor). The photosensitive drum 25 may be rotatably disposed on the cartridge body and include a steel axle 25a. The charging roller 24 may be configured to charge the photosensitive drum 25. During the printing process of the image-forming apparatus 100, the stirring frame 11 in the toner cartridge 1 may rotate to transfer the toner from the toner cartridge 1 to the process cartridge 2, and the stirring screw 21 in the process cartridge 2 may stir the developer in a toner bin to make the developer uniformly charged and then transfer the developer to the toner supply screw 22. The toner supply screw 22 may make the surface of the magnetic roller 23 have a uniform developer layer. Meanwhile, the charging roller 24 may charge the photosensitive drum 25, and the LSU (laser scanning unit) may expose the photosensitive drum 25 to form an electrostatic latent image on corresponding surface; and simultaneously the charges generated by the exposure on the photosensitive drum 25 may be discharged along the steel axle 25a of the photosensitive drum 25. At this point, the developer on the magnetic roller 23 may make the electrostatic latent image of the photosensitive drum 25 form a toner image, the primary transfer, secondary transfer and fixing may be then performed successively, and finally the image to be printed may be formed on the paper.

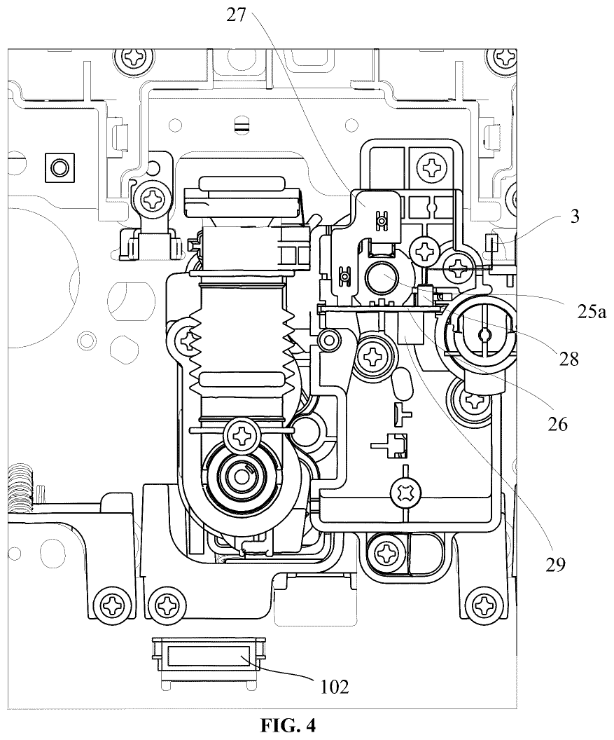

Referring to FIGS. 4-5, FIG. 4 illustrates a structural schematic of a process cartridge provided by exemplary embodiments of the present disclosure; and FIG. 5 illustrates an electrical connection structural schematic of a photosensitive drum, a chip and a discharge component provided by exemplary embodiments of the present disclosure. The process cartridge may further include a chip 26 and a first conductive part 27. The chip 26 may be disposed on the cartridge body and include a power supply contact 261. The chip 26 may receive power (electricity) from the image-forming apparatus through the power supply contact 261. The chip 26 may be configured to store relevant parameters of the process cartridge, such as the lifetime of the process cartridge, remaining amount of the toner and the like. The first conductive part 27 may be electrically connected to the steel axle 25a of the photosensitive drum 25 and the power supply contact 261 of the chip 26, such that the chip 26 and the photosensitive drum 25 may be electrically connected to each other through the first conductive part 27. In one embodiment, the discharge component 3 may be configured on the cartridge body and electrically connected to the chip 26, which may be configured to eliminate the charges generated by the photosensitive drum 25 after exposure, thereby ensuring the stability of the surface potential of the photosensitive drum 25. When the process cartridge is installed on the main body 101 of the image-forming apparatus 100, the chip 26 may be electrically connected to the main body 101 of the image-forming apparatus 100. At this point, the chip 26, the discharge component 3 and the photosensitive drum 25 may work normally; the charges generated by the photosensitive drum 25 after exposure may be transferred to the steel axle 25a; the charges may then be transferred to the chip 26 through the first conductive part 27; and finally, the charges may be discharged through a chip base.

In one embodiment, the discharge component 3 may be configured on the cartridge body of the process cartridge. In one embodiment, the discharge component 3 may be configured as a discharge lamp, and the discharge component 3 may be configured as a lamp bead. It may be understood that in other embodiments, the discharge component 3 may also be configured on the image-forming apparatus 100 and may also be configured as an LED lamp. In other embodiments, the discharge component 3 may also be configured as a discharge electrode wire.

In some embodiments, the first conductive part 27 may be, for example, a conductive wire, a conductive sheet, or other conductive structure. The first conductive part 27 may not be configured on the process cartridge, but may be a separate part, which may be not limited in the present disclosure.

In one embodiment, when the chip 26 is electrically connected to the main body 101 of the image-forming apparatus 100, under the action of the discharge component 3, the charges generated by the photosensitive drum 25 after exposure may be discharged through the steel axle 25a, the first conductive part 27 and the chip 26. That is, the main body 101 of the image-forming apparatus 100 may only need to be configured with a power supply pin corresponding to the power supply contact 261 of the chip 26, and there may be no need to simultaneously provide a plurality of power supply pins corresponding to the chip 26, the photosensitive drum 25 and the discharge component 3, thereby reducing the number of power supply pins needed to be configured on the main body 101 of the image-forming apparatus 100, simplifying the frame structure of the consumables and the image-forming apparatus and reducing the cost.

For example, the main body 101 of the image-forming apparatus 100 may be configured with the third electrical connection part 102. The process cartridge 2 may further include the first electrical connection part 28 and the second electrical connection part 29; the first electrical connection part 28 may be configured on the chip 26; and the discharge component 3 may be detachably connected to the first electrical connection part 28. The second electrical connection part 29 may be configured on the chip 26 for electrical connection with the main body 101 of the image-forming apparatus 100; and the second electrical connection part 29 and the first electrical connection part 28 may be respectively configured on two opposite sides of the chip 26. When the process cartridge is installed on the main body 101 of the image-forming apparatus 100, the electrical connection between the main body of the image-forming apparatus and the discharge component 3, the photosensitive drum 25 and the chip 26 may be realized by connecting the second electrical connection part 29 and the third electrical connection part 102 through a conductive wire. Therefore, under the action of the discharge component 3, the charges generated by the photosensitive drum 25 after exposure may be discharged through the steel axle 25a, the first conductive part 27 and the chip 26. In one embodiment, the first electrical connection part 28, the second electrical connection part 29 and the third electrical connection part 102 may be a socket part, which may be directly inserted into the chip of the process cartridge for use, such that the removal and installation operations between the discharge component 3 and the chip 26, and between the chip 26 and the image-forming apparatus and other parts may be more convenient.

In one embodiment, the first electrical connection part 28 may be configured to facilitate the connection or disconnection between the discharge component 3 and the chip 26, and the second electrical connection part 29 may be configured to facilitate the connection or disconnection between the chip 26 and the main body 101 of the image-forming apparatus 100. Furthermore, since the first electrical connection part 28 and the second electrical connection part 29 are configured on two opposite sides of the chip 26, the area occupied by the chip 26 may be reduced, and the chip 26 may be designed to be relatively small, which may reduce the space occupied by the process cartridge, make the process cartridge more compact and reduce the cost. In other embodiments, the first electrical connection part 28 and the second electrical connection part 29 may not be configured on the process cartridge, but may be separate accessories, which may not be limited in the present disclosure.

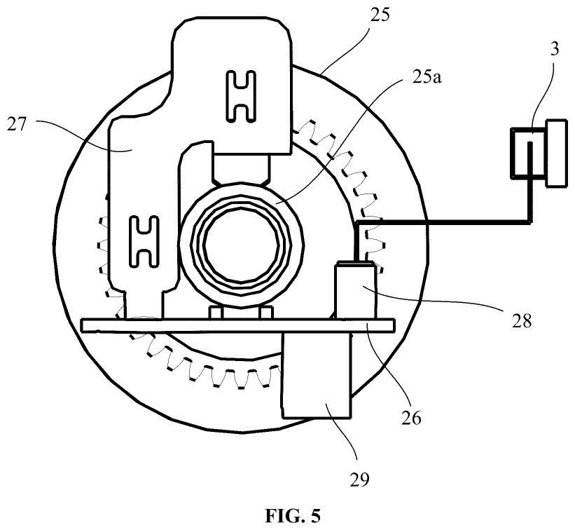

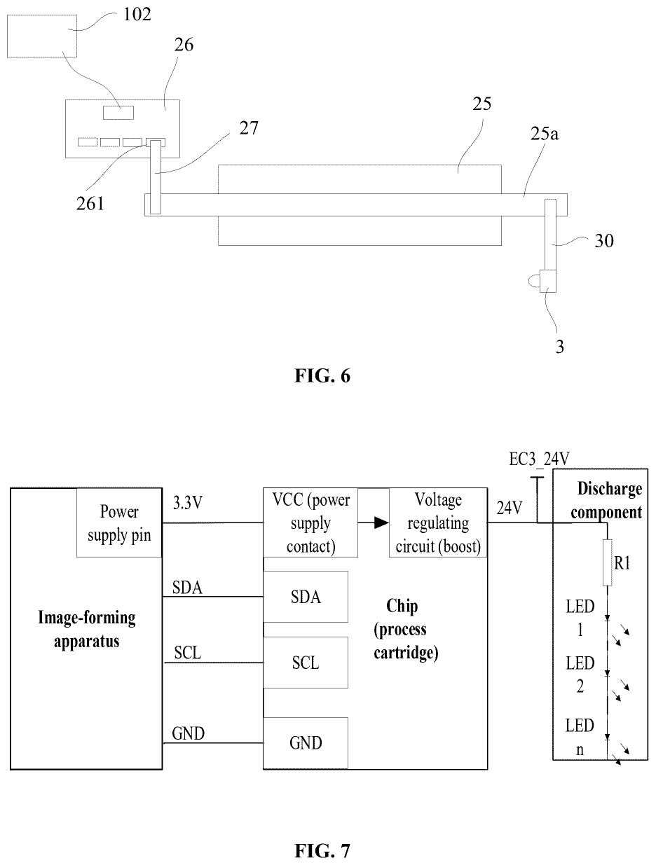

Based on above-mentioned embodiments, the present disclosure also discloses another implementation manner. The difference between one embodiment and above-mentioned embodiments is described hereinafter. As shown in FIG. 6, FIG. 6 illustrates another electrical connection structural schematic of the photosensitive drum, the chip and the discharge component 3 provided by exemplary embodiments of the present disclosure. In one embodiment, the power supply contact 261 of the chip 26 may be electrically connected to the discharge component 3 through the steel axle 25a of the photosensitive drum 25. For example, the first end of the steel axle 25a and the power supply contact 261 may be electrically connected to each other through the first conductive part 27; the second end of the steel axle 25a and the discharge component 3 may be electrically connected to each other through the second conductive part 30; and the power supply contact 261 of the chip 26 may be directly and electrically connected to the third electrical connection part 102 configured in the main body of the image-forming apparatus through a conductive wire or a socket part, thereby realizing the electrical connection between the main body of the image-forming apparatus and the discharge component 3, the photosensitive drum 25 and the chip 26.

In some embodiments, the second conductive part 30 may be, for example, a conductive wire, a conductive sheet, or other conductive structures.

Furthermore, the chip 26 and the discharge component 3 may be at two ends of the steel axle 25a; and the first conductive part 27 and the second conductive part 30 may be respectively connected to two ends of the steel axle 25a. In one embodiment, the chip 26 and the discharge component 3 may be configured at two ends of the steel axle 25a, thereby making full use of the space in the process cartridge and further making the layout more compact.

In one embodiment, when the chip 26 is electrically connected to the main body 101 of the image-forming apparatus 100, the discharge component 3 may work normally, and the charges generated by the photosensitive drum 25 after exposure may be discharged through the steel axle 25a, the second conductive part 30 and the chip 26. That is, the main body 101 of the image-forming apparatus 100 may only need to have the power supply pin corresponding to the chip electrical contact, thereby reducing the quantity of power supply pins needed to be configured on the main body 101 of the image-forming apparatus 100, simplifying the frame structure of the consumables and the image-forming apparatus and reducing the cost.

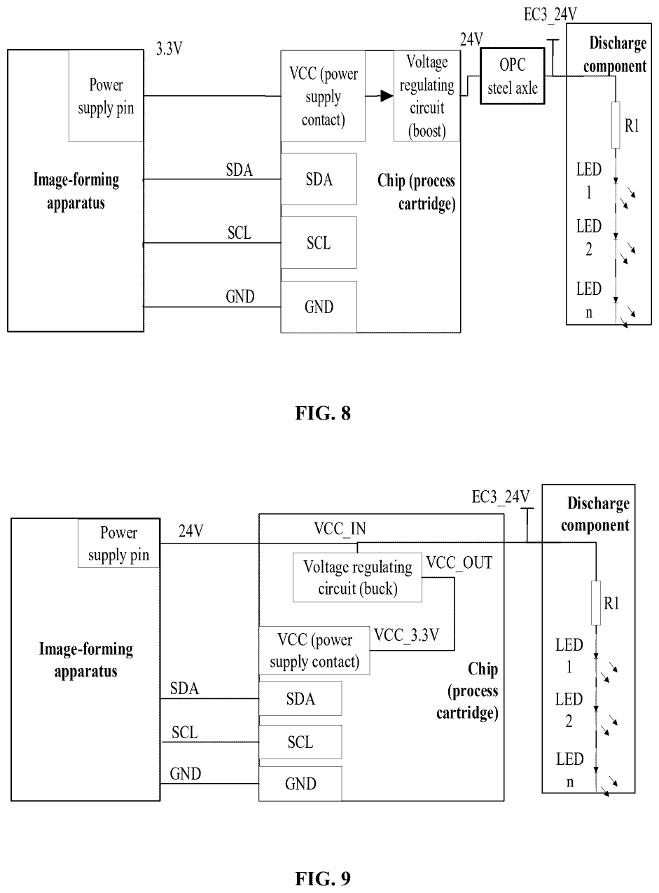

In one embodiment, the process cartridge may include a voltage regulating circuit, and the power supply contact may be electrically connected to the discharge component through the voltage regulating circuit. The voltage regulating circuit may adopt a boost circuit or a buck circuit according to actual situation. For example, in one embodiment, the power supply contact VCC may be electrically connected to the discharge component through the boost circuit. Referring to FIG. 7, the chip in the process cartridge may be electrically connected to the image-forming apparatus. The chip may include the power supply contact VCC and the voltage regulating circuit (boosting circuit). The power supply contact VCC may be configured to be electrically connected to the image-forming apparatus to receive power supply from the image-forming apparatus. In other embodiments, the voltage regulating circuit (boosting circuit) may be not configured on the chip, for example, may be a separate circuit module configured on the cartridge body of the process cartridge. For example, the power supply contact VCC, the boosting circuit and the discharge component may be electrically connected in sequence. In another embodiment, as shown in FIG. 8, the power supply contact VCC, the boost circuit, the OPC steel axle and the discharge component may be electrically connected in sequence. The difference from above-mentioned embodiment is that the boost circuit and the discharge component may be connected to each other through the steel axle of the photosensitive drum as the conductive part. It should be noted that in above-mentioned two embodiments, the power supply contact VCC may be the chip's own power supply contact, which may provide the chip with the voltage needed for normal operation, such as 3.3V. The voltage needed by the discharge component may be higher than the voltage of the power supply contact VCC of the chip, so that the boost circuit may be needed to increase the chip voltage (3.3V) to the voltage needed by the discharge component. The voltage needed by the discharge component may be determined according to the type of the discharge component or the quantity of lamp beads included in the discharge component. For example, if the voltage needed by the discharge component is 24V, the boost circuit may increase 3.3V to 24V. The boost circuit may use a DC/DC boost chip which may be a conventional circuit structure, which may be not described in detail herein.

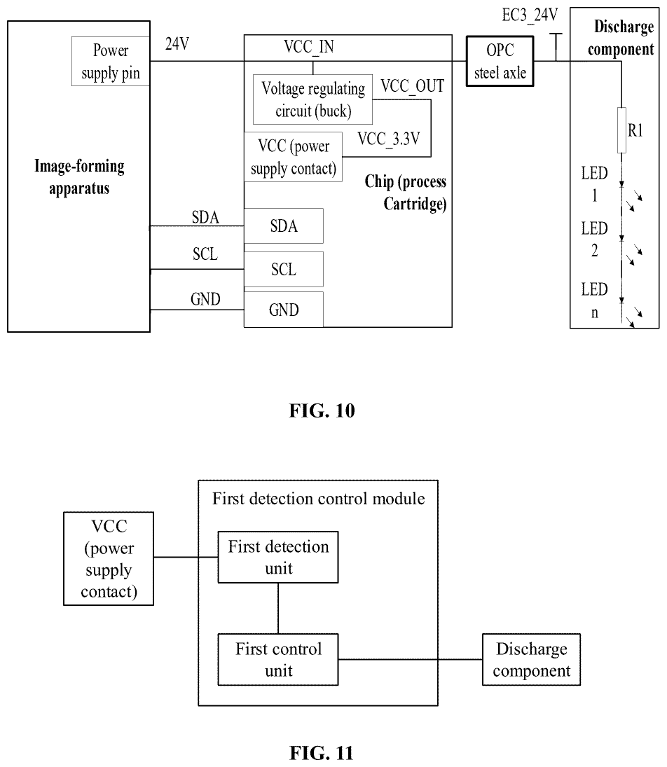

In another embodiment of the present disclosure, the power supply contact VCC may be electrically connected to the discharge component through the buck circuit. As shown in FIG. 9, the chip may include the power supply contact VCC, a VCC_IN contact, and the voltage regulating circuit (buck circuit); and the buck circuit may be connected between the power supply contact VCC and the VCC_IN contact. In other embodiments, the voltage regulating circuit (buck circuit) may not be configured on the chip, for example, may be a separate circuit module configured on the cartridge body of the process cartridge. In one embodiment, the power supply contact VCC is the chip's own power supply contact, which may provide the chip with the voltage needed for normal operation, such as 3.3V. The VCC_IN contact may be a newly added electrical contact on the chip, which may be electrically connected to the image-forming apparatus and the discharge component respectively and may receive power supply from the image-forming apparatus and provide the discharge component with the voltage needed for the normal operation of the discharge component, such as 24V. The voltage (24V) outputted by the VCC_IN contact may be reduced to actual voltage (3.3V) needed by the chip through the voltage regulating circuit (buck circuit) and then transmit actual voltage to the power supply contact VCC, such that the chip may work normally. In another embodiment, as shown in FIG. 10, the power supply contact VCC, the buck circuit, the OPC steel axle and the discharge component may be electrically connected in sequence. The difference from above-mentioned embodiment is that the buck circuit and the discharge component may be connected to each other through the steel axle of the photosensitive drum as the conductive part. The buck circuit usually may adopt a DC/DC buck chip which may be a conventional circuit structure, which may not be described in detail herein. Furthermore, exemplarily, the voltage regulating circuit may include, but may be not limited to, a voltage dividing circuit or above-mentioned buck (boost) circuit. Obviously, for the stable transmission of the signal, the voltage regulating circuit may also include a voltage stabilizing circuit, a filtering circuit and the like, which may not be described in detail herein. The voltage dividing circuit may be configured to perform voltage division processing on the signal received by the voltage dividing circuit to obtain a signal after voltage division, which may be exemplarily configured to reduce the voltage of the signal inputted into the voltage dividing circuit. The voltage stabilizing circuit may be configured to perform voltage stabilizing processing on the signal received by the voltage stabilizing circuit to obtain a voltage-stabilized signal, which may play a role in voltage stabilization to prevent excessive voltage from damaging the circuit. The voltage stabilizing circuit may also include parts or circuits that may play a role in voltage stabilization. And/or the filtering circuit may be configured to perform filtering processing on the signal received by the filtering circuit to obtain a filtered signal, which may exemplarily filter out part of the signal to prevent breakdown of the module connected thereto and protect the circuit from damage.

In one embodiment of the present disclosure, as shown in FIG. 11, the power supply contact VCC of the chip of the process cartridge may be connected to the first detection control module. It should be noted that the first detection control module may be a functional module directly configured on the chip of the process cartridge or may not be configured on the chip but be configured separately as an independent functional module, which may be electrically connected to the power supply contact VCC of the chip through a conductive part. For example, the first detection control module may include the first detection unit and the first control unit. The first detection unit may be configured to be connected to the power supply contact VCC and configured to detect whether the power supply contact VCC receives power from the image-forming apparatus. The first control unit may be configured to obtain the detection result of the first detection unit. When the detection result is that the power supply contact VCC receives power, the discharge component may be controlled to be in an ON state (turn-on); and when the detection result is that the power supply contact VCC does not receive power, the discharge component may be controlled to be in an OFF state (turn-off). Such design may enable the first detection control module to control the output or non-output of power to the discharge component according to the application scenario of the image-forming apparatus, which may improve the compatibility of the process cartridge of the present disclosure. Furthermore, in embodiments of the present disclosure, above-mentioned power supply contact VCC may be replaced with other power supply contacts included in the chip of the process cartridge that may receive power from the image-forming apparatus, which may not be limited in embodiments of the present disclosure.

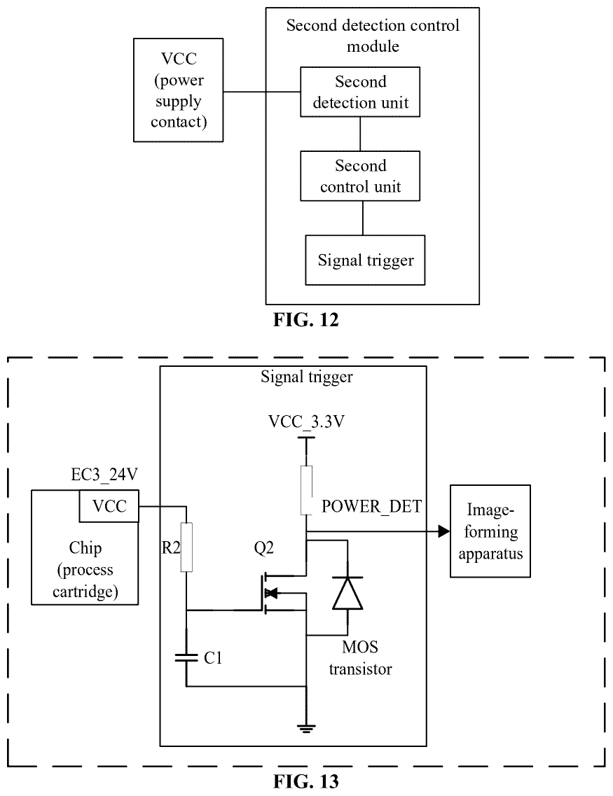

In one embodiment of the present disclosure, as shown in FIG. 12, the power supply contact VCC of the chip of the process cartridge may be connected to the second detection control module. It should be noted that the second detection control module may be a functional module directly configured on the chip of the process cartridge or may not be configured on the chip but be configured separately as an independent functional module, which may be electrically connected to the power supply contact VCC of the chip through a conductive part. For example, the second detection control module may include the second detection unit, the signal trigger and the second control unit. The second detection unit may be configured to be connected to the power supply contact VCC of the chip and detect whether the power supply contact VCC receives power from the image-forming apparatus. The signal trigger may be configured to generate a level signal. The second control unit may be configured to obtain the detection result of the second detection unit; when the detection result is that the power supply contact VCC receives power, the control signal trigger may generate the first-level signal; and when the detection result is that the power supply contact VCC does not receive power, the control signal trigger may generate the second-level signal, where the first-level signal may be different from the second-level signal. For example, when the power supply contact VCC receives power from the image-forming apparatus, the image-forming apparatus may obtain a low-level signal through corresponding internal detection circuit, and the signal trigger may generate the first-level signal identical to the low-level signal according to the detection result of the second detection unit, and feed the first-level signal back to the image-forming apparatus. When the power supply contact VCC does not receive power from the image-forming apparatus, the image-forming apparatus may obtain a high-level signal through corresponding internal detection circuit, and the signal trigger may generate the second-level signal identical to the high-level signal according to the detection result of the second detection unit, and feed the second-level signal back to the image-forming apparatus. Such setting may improve the compatibility of the process cartridge of the present disclosure. As shown in FIG. 13, in an optional embodiment of the present disclosure, the signal trigger may include a MOS transistor, that is, the internal circuit of the signal trigger may be turned on or cut off by the MOS transistor. For example, when there is power output at the output terminal of the power supply contact of the chip of the process cartridge of the present disclosure, the MOS transistor in the signal trigger may be turned on for conduction, and the POWER_DET state fed back to the image-forming apparatus may be the low-level signal (i.e., the first-level signal). When there is no power output at the output terminal of the power supply contact of the chip of the process cartridge of the present disclosure, the MOS transistor in the signal trigger may be not turned on for conduction, and the POWER_DET state fed back to the image-forming apparatus may be the high-level signal (the second-level signal). Obviously, in other embodiments, the signal trigger may also be configured to other circuit structures, which may be not limited by the present disclosure. Furthermore, in embodiments of the present disclosure, above-mentioned power supply contact VCC may be replaced by other power supply contacts contained in the chip of the process cartridge that may be capable of receiving power from the image-forming apparatus, which may be not limited in embodiments of the present disclosure.

In one embodiment of the present disclosure, as shown in FIG. 14, the power supply contact VCC of the chip of the process cartridge may be connected to the third detection control module. It should be noted that the third detection control module may be a functional module directly configured on the chip of the process cartridge or may not be configured on the chip but configured separately as an independent functional module, which may be electrically connected to the power supply contact VCC of the chip through a conductive part. For example, the third detection control module may include the third detection unit and the third control unit. In one embodiment, the third detection unit may be configured to be connected to the power supply contact VCC and detect the time points T1 and T2 when the power supply contact VCC receives power consecutively twice (e.g., the time points when the printer or the image-forming apparatus is powered on consecutively twice). The third control unit may be connected to the third detection unit and configured to determine the time interval Δt1 between T1 and T2 according to the detection result of the third detection unit and control the time interval Δt2 of the state switches of the discharge component according to the time interval Δt1. In another embodiment, the third detection unit may be configured to be connected to the power supply contact VCC to detect the time interval Δt1 between the time points of the power supply contact VCC receiving power consecutively twice; the third control unit may be connected to the third detection unit and control the time interval Δt2 of the state switches of the discharge component according to the time interval Δt1 fed back by the third detection unit. For example, the time interval Δt2 of the state switches of the discharge component may be adjusted to be same as the time interval Δt1 fed back by the third detection unit, which may avoid the case that the image-forming apparatus is easy to have error when the process cartridge of the present disclosure is installed in the image-forming apparatus, thereby improving the user experience. Furthermore, in embodiments of the present disclosure, above-mentioned power supply contact VCC may be replaced by other power supply contacts contained in the chip of the process cartridge that may be capable of receiving power from the image-forming apparatus, which may be not limited in embodiments of the present disclosure.

The present disclosure provides an image-forming apparatus. The image-forming apparatus may include an image-forming unit and a power supply pin. The image-forming unit may be configured to perform the image-forming operation; the power supply pin may be configured to supply power to the chip configured on the cartridge body of the process cartridge when the process cartridge is installed in the image-forming apparatus, and configured to supply power to the discharge component electrically connected to the chip through the chip; and the discharge component may be configured to eliminate the residual charge on the photosensitive drum.

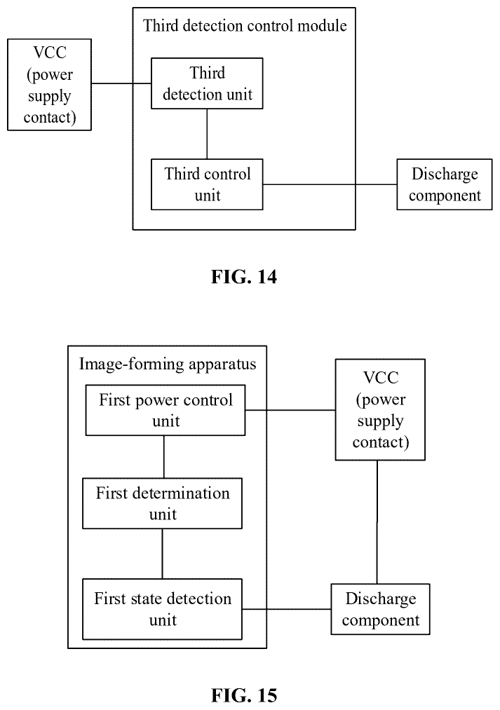

In one embodiment of the present disclosure, as shown in FIG. 15, the image-forming apparatus may further include the first state detection unit, the first power control unit, and the first determination unit. The first state detection unit may be electrically connected to the discharge component and configured to detect the ON/OFF state of the discharge component; the first power control unit may be configured to control the turn-on/turn-off of the power provided by the image-forming apparatus to the power supply contact VCC of the chip; the first determination unit may be configured to determine whether the process cartridge satisfies expectation according to the detection result of the first state detection unit when the first power control unit is disconnected from the power supply. In one embodiment, when the first power control unit is disconnected from the power supply, the discharge component cannot receive power from the power supply contact VCC of the chip of the process cartridge and should be in the OFF state. If the first state detection unit detects that the discharge component is in the ON state at this point, it may be determined that the connected process cartridge at this point may not satisfy expectation. Therefore, by controlling the chip to provide power or not to provide power to the chip, the image-forming apparatus may determine whether the process cartridge satisfies expectation according to whether the state of the discharge component satisfies expectation.

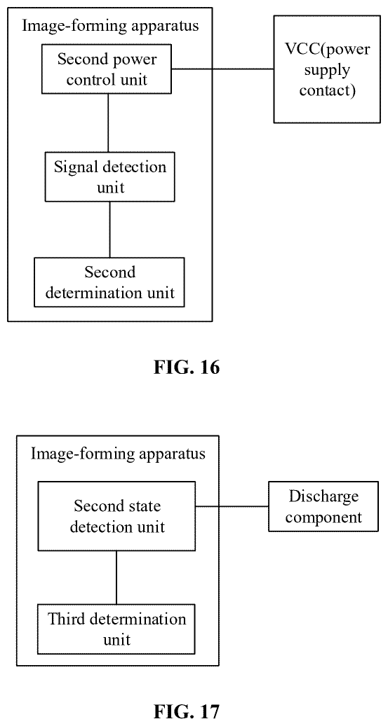

In one embodiment of the present disclosure, as shown in FIG. 16, the image-forming apparatus may further include a second power control unit, a signal detection unit, and a second determination unit. The second power control unit may be configured to control the turn-on and turn-off of the power provided by the image-forming apparatus to the power supply contact VCC of the chip; the signal detection unit may be configured to obtain the signal detection result according to the control result of the second power control unit on the power supply; and the second determination unit may be configured to determine whether the process cartridge satisfies expectation according to the signal detection result. For example, when the second power control unit controls the image-forming apparatus to provide power to the power supply contact VCC of the chip, the signal detection unit may obtain the signal at the output terminal of the power supply contact VCC and feedback the signal detection result to the second determination unit. If the signal detection unit feedback a low-level signal to the second determination unit according to the detected signal, the second determination unit may determine that the process cartridge connected to the image-forming apparatus satisfies expectation. If the signal detection unit feedback a high-level signal, the second determination unit may determine that the process cartridge connected to the image-forming apparatus does not satisfy expectation. Obviously, in other embodiments, when the image-forming apparatus provides power to the power supply contact VCC of the chip, the signal detection unit may feedback a high-level signal; and when the image-forming apparatus does not provide power to the power supply contact VCC of the chip, the signal detection unit may feedbacks a low-level signal, which may not be limited in embodiments of the present disclosure. Obviously, the level signal detected by the signal detection unit may also be replaced by an electrical signal such as an analog signal, which may not be limited in the present disclosure. In one embodiment, the implementation manner of the signal detection unit may be similar to the implementation manner of the signal trigger in FIG. 13. The signal detection unit may also realize the turn-on or cut-off function of corresponding internal circuit by using a MOS transistor. For example, when the second power control unit controls the image-forming apparatus to provide power to the power supply contact VCC of the chip, the MOS transistor may be turned on for conduction, and the POWER_DET state fed back to the image-forming apparatus may be a low-level signal. When the second power control unit controls the image-forming apparatus to stop providing power to the power supply contact VCC of the chip, the MOS transistor may be not turned on for conduction, and the POWER_DET state fed back to the image-forming apparatus may be a high-level signal. Therefore, by controlling the chip to provide power or not to provide power to the chip, the image-forming apparatus may determine whether the process cartridge satisfies expectation according to whether the signal detected by the signal detection unit satisfies expectation.

In one embodiment of the present disclosure, as shown in FIG. 17, the image-forming apparatus may further include the second state detection unit and the third determination unit. The second state detection unit may be configured to be electrically connected to the discharge component and configured to detect the time points t1 and t2 when the discharge component switches to the ON state consecutively twice. The third determination unit may be configured to determine the time interval between two consecutive ON state switches of the discharge component to the t1 and the t2, compare the time interval with a preset time interval, and determine whether the process cartridge satisfies expectation according to the comparison result. In another embodiment, the second state detection unit may be configured to be electrically connected to the discharge component, and configured to detect the time interval between time points when the discharge component switches to the ON state consecutively twice; the third determination unit may be configured to obtain the time interval, compare the time interval with the preset time interval, and determine whether the process cartridge satisfies expectation according to the comparison result. Through above-mentioned embodiments, when detected time interval is different from the preset time interval, it determines that the process cartridge installed in the image-forming apparatus may not satisfy expectation. Therefore, by controlling the image-forming apparatus provide power to the chip at least twice, the image-forming apparatus may determine whether the process cartridge satisfies expectation based on the time interval of the state switching time points of the discharge component obtained by detection.

Compared with the existing technology, the technical solutions provided by the present disclosure may achieve at least following beneficial effects.

Compared with the existing technology, the process cartridge of the present disclosure may include the cartridge body, the photosensitive drum and the chip. The chip may include the power supply contact that may receive power from the image-forming apparatus. The power supply contact may be configured to be electrically connected to the discharge component, and the discharge component may be configured to eliminate the residual charge on the photosensitive drum. When the process cartridge is installed on the main body of the image-forming apparatus, the image-forming apparatus may supply power to the power supply contact of the chip and then supply power to the discharge component through the power supply contact of the chip. That is, the main body of the image-forming apparatus may only need to be configured with the power supply pin corresponding to the power supply contact of the chip, and there may be no need to simultaneously provide a plurality of power supply pins corresponding to the chip and the discharge component, thereby reducing the quantity of power supply pins needed to be configured on the main body of the image-forming apparatus, further reducing the cost and having a simpler structure and a smaller size.

The above may be optional embodiments of the present disclosure, which may not limit the protection scope of the present disclosure. Any changes or substitutions that may be easily thought by those skilled in the art within the technical scope disclosed in the present disclosure should be included in the protection scope of the present disclosure. Therefore, the protection scope of the present disclosure should be based on the protection scope of the claims.

What is claimed is:

1. A process cartridge, detachably mounted on an image-forming apparatus, comprising:
a cartridge body;
a photosensitive drum, rotatably disposed on the cartridge body; and
a chip, configured to be disposed on the cartridge body, wherein the chip includes a power supply contact configured to receive power provided by the image-forming apparatus, wherein:
the power supply contact is configured to be electrically connected to a discharge component, and the discharge component is configured to eliminate residual charge on the photosensitive drum.

2. The process cartridge according to claim 1, wherein:
the process cartridge further includes a first electrical connection part, wherein the first electrical connection part is configured to electrically connect the power supply contact with the discharge component.

3. The process cartridge according to claim 2, wherein:
the first electrical connection part is disposed on the chip and electrically connected to the power supply contact; and the discharge component is capable of being detachably connected to the first electrical connection part.

4. The process cartridge according to claim 2, wherein:
the process cartridge further includes a second electrical connection part, wherein the second electrical connection part is configured to electrically connect the power supply contact with the image-forming apparatus.

5. The process cartridge according to claim 4, wherein:
the second electrical connection part is disposed on the chip and electrically connected to the power supply contact; and the first electrical connection part and the second electrical connection part are respectively configured on two opposite sides of the chip.

6. The process cartridge according to claim 1, wherein:
the photosensitive drum includes a steel axle; wherein the steel axle is configured to electrically connect the power supply contact with the discharge component.

7. The process cartridge according to claim 6, wherein:
a first end of the steel axle is electrically connected to the power supply contact through a first conductive part, and a second end of the steel axle is electrically connected to the discharge component through a second conductive part.

8. The process cartridge according to claim 1, wherein:
the process cartridge includes a voltage regulating circuit, and the power supply contact is capable of being electrically connected to the discharge component through the voltage regulating circuit.

9. The process cartridge according to claim 5, wherein:
the power supply contact is capable of being electrically connected to the discharge component through the voltage regulating circuit and the photosensitive drum.

10. The process cartridge according to claim 1, further including:
a first detection control module, wherein the first detection control module includes:
a first detection unit, connected to the power supply contact and configured to detect whether the power supply contact receives the power from the image-forming apparatus; and
a first control unit, configured to obtain a detection result of the first detection unit; when the detection result is that the power supply contact receives the power, control the discharge component to be in an ON state; and when the detection result is that the power supply contact does not receive the power, control the discharge component to be in an OFF state.

11. The process cartridge according to claim 1, further including:
a second detection control module, wherein the second detection control module is configured to generate a level signal correspondingly according to a status of the power obtained by the power supply contact.

12. The process cartridge according to claim 11, wherein:
the second detection control module includes:
a second detection unit, connected to the power supply contact and configured to detect whether the power supply contact receives the power;
a signal trigger, configured to generate a level signal; and
a second control unit, configured to obtain a detection result of the second detection unit; when the detection result is that the power supply contact receives the power, control the signal trigger to generate a first-level signal; and when the detection result is that the power supply contact does not receive the power, control the signal trigger to generate a second-level signal, wherein the first-level signal is different from the second-level signal.

13. The process cartridge according to claim 1, wherein:
the process cartridge further includes a third detection control module, wherein the third detection control module is configured to control state switching time points of the discharge component according to two consecutive time points of receiving power from the image-forming apparatus.

14. The process cartridge according to claim 13, wherein:
the third detection control module includes a third detection unit, connected to the power supply contact and configured to detect time points T1 and T2 when the power supply contact receives power consecutively twice; and a control unit, configured to control state switching time points of the discharge component according to the time points T1 and T2 detected by the third detection unit; or
the third detection control module includes a third detection unit, connected to the power supply contact and configured to detect a time interval between time points of the power supply contact receiving power consecutively twice; and a control unit, configured to obtain the time interval detected by the third detection unit and control a time interval of state switches of the discharge component according to the time interval detected by the third detection unit.

15. An image-forming apparatus, comprising:
an image-forming unit, configured to perform an image-forming operation; and
a power supply pin, configured to supply power to a chip disposed on a cartridge body of a process cartridge when the process cartridge is installed in the image-forming apparatus, and further configured to supply power to the discharge component, wherein the discharge component is configured to eliminate residual charge on a photosensitive drum.

16. The image-forming apparatus according to claim 15, further including:
a first state detection unit, configured to be electrically connected to the discharge component and detect an ON or OFF state of the discharge component;
a first power control unit, configured to control connection and disconnection of the power provided by the image-forming apparatus to the chip; and
the first determination unit, configured to determine whether the process cartridge satisfies expectation according to a detection result of the first state detection unit when the power is disconnected by the first power control unit.

17. The image-forming apparatus according to claim 15, further including:
a second power control unit, configured to control connection and disconnection of the power provided by the image-forming apparatus to the chip;
a signal detection unit, configured to obtain a signal detection result according to a control result of the second power control unit on the power; and
a second determination unit, configured to determine whether the process cartridge satisfies expectation according to the signal detection result.

18. The image-forming apparatus according to claim 15, further including:
a second state detection unit, configured to be electrically connected to the discharge component and configured to detect time points t1 and t2 when the discharge component switches to an ON state consecutively twice; and a third determination unit, configured to determine a time interval between two consecutive ON state switches of the discharge component according to the time points t1 and t2, compare the time interval with a preset time interval, and determine whether the process cartridge satisfies expectation according to a comparison result; or
a second state detection unit, configured to be electrically connected to the discharge component and configured to detect a time interval between two consecutive ON state switches of the discharge component; and a third determination unit, configured to obtain the time interval and compare the time interval with a preset time interval, and determine whether the process cartridge satisfies expectation according to a comparison result.
